(19) United States
(12) Patent Application Publication
(10) Pub. No.: US 2010/0245686 A1
(43) Pub. Date: Sep. 30, 2010

(54) SYSTEM AND METHOD FOR MODULAR LED ILLUMINATION

(75) Inventor: Estill Thone Hall, JR., Fishers, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/740,950

(22) PCT Filed: Dec. 27, 2007
(86) PCT No.: PCT/US07/88961

§ 371 Date: Apr. 30, 2010

(30) Foreign Application Priority Data
Dec. 4, 2007 (CN) 200710124803.8

(51) Int. Cl. H04N 5/74; F21V 1/00; F21V 9/00

(52) U.S. Cl. 348/750; 362/235; 362/231; 348/E05.137

(57) ABSTRACT

The present invention is directed to an illumination system of a video unit. In an exemplary embodiment of the present invention, the illumination system comprises a module comprising a plurality of light emitting diodes (LEDs) adapted to emit light. The illumination system further includes a plurality of lens elements disposed subsequent to the LEDs. The plurality of lens elements is adapted to distribute intensity of the light emitted by the LEDs across an aperture. In addition the intensity of the light at the aperture directly corresponds to the location of the LEDs within the module.

### FIELD OF THE INVENTION

The present invention relates generally to video display and projection systems. More specifically, the present invention relates to illumination systems of the video display and projection system.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Typically, video display and projection systems employ an illumination system, i.e., a light engine for generating light ultimately used to form an image. For example, microdisplay systems, such as digital light processor (DLP) systems, include an illumination system utilizing a specialized high pressure mercury arc lamp as an illumination source. Such lamps provide the illumination system initially with white light, which is subsequently split/dispersed using optical devices (e.g., color wheel) into three primary colors, namely, red green and blue (RGB). Thereafter, the RGB light is combined using yet additional optical devices for generating a colored image. In such systems, the optical and other devices used to split and recombine the light may have light-gathering efficiencies that are relatively low. This may limit or otherwise compromise image quality. In addition, the aforementioned light dispersing and/or combining optical components may occupy a substantial space within the illumination and projection systems in which they are used. Accordingly, these optical devices may render the video display unit quite large. In addition, the arc lamps used in such systems may have a relatively short lifetime and may require frequent replacement. Moreover, replacing the lamp may be cumbersome, requiring major disassembly of the entire display system and/or some of its elements. Furthermore, mercury contained within the above mentioned arc lamps render those lamps environmentally unfriendly, especially when those are disposed of in an unsafe manner.

There is accordingly a need for video units not requiring the use of arc lamps as an illumination source. Furthermore, there is a need for an efficient illumination system that provides a sufficient amount of light for producing a viewable image.

### BRIEF DESCRIPTION OF THE DRAWINGS

Advantages of the invention may become apparent upon reading the following detailed description and upon reference to the drawings in which:

FIG. 1 is a block diagram of a video unit in accordance with an exemplary embodiment of the present invention;

FIG. 2 is a block diagram of an illumination system in accordance with an exemplary embodiment of the present invention;

FIG. 3 is a rear view of a lenslet assembly, in accordance with an exemplary embodiment of the present invention;

FIG. 4 is a rear view of another lenslet assembly in accordance with an exemplary embodiment of the present invention;

FIG. 5 is a perspective view of an LED module disposed relative to the lenslet assembly shown in FIG. 4, in accordance with an exemplary embodiment of the present invention; and

FIG. 6 is a process flow diagram showing a method of operating an illumination system of a video unit in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

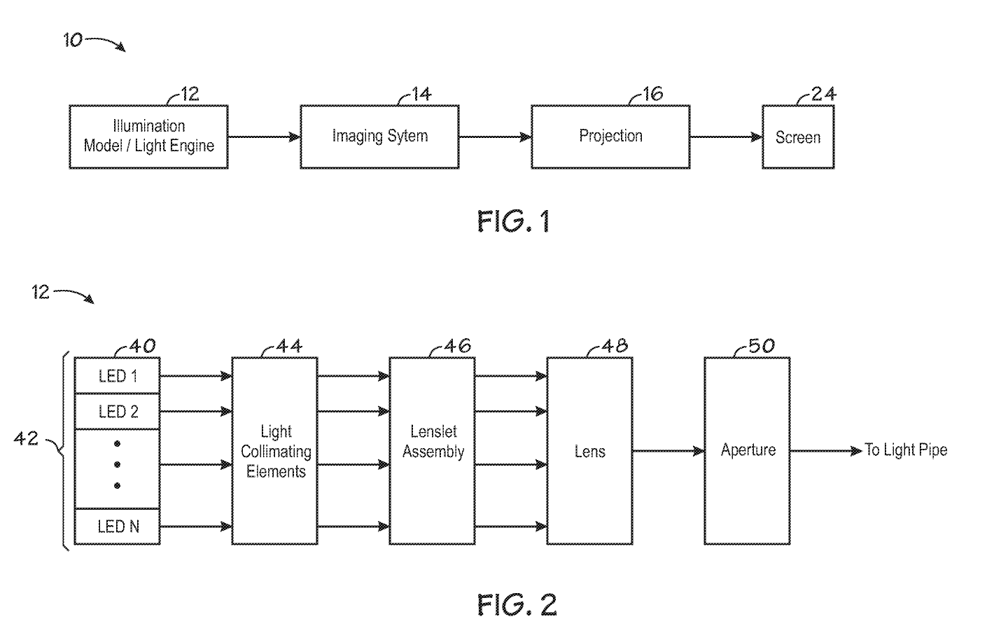

Turning initially to FIG. 1, a block diagram of a video unit in accordance with one exemplary embodiment of the present invention is illustrated and generally designated by a reference numeral 10. In the illustrated embodiment, the video unit 10 may comprise a Digital Light Processing (“DLP”) projection television or projector or the like. In another embodiment, the video unit 10 may comprise a liquid crystal display (“LCD”) projection television or projector or the like. In still other embodiments, the video unit 10 may comprise a liquid crystal on silicon (LCOS) projector, a high temperature poly-silicon (HTPS) or another suitable form of projection television or display.

The video unit 10 includes a light engine/illumination system 12. The illumination system 12 is configured to generate white or colored light that can be employed by an imaging system 14 to create a video image. As will be discussed in further detail below, the illumination system 12 includes optical and electro-optical components adapted to replace arc lamps otherwise used in conventional systems. The illumination system 12 includes a collection of pulsed light emitting diodes (LEDs) adapted to emit, for example, RGB light at various intensities. As will be further shown below, the illuminations system 12 further includes an optical device, referred herein to as a lenslet assembly. The lenslet assembly is a collection of lens elements whose number is equal to the number of the LEDs included in a module of the illuminations system 12. The lenslet assembly is adapted to collect and further transmit the RGB light emanating from the LEDs onto an aperture. As shown below, each of the lenslets in the lenslet assembly is uniquely positioned within the illumination system 12 for transmitting the light onto an aperture. Further, the positioning of each of lenslets within the illumination system is designed to provide a unique intensity profile of each light color emanating from the LEDs across the aperture. This intensity profile is provided from the aperture to additional components, such as projection and imaging devices, of the video display unit for producing images having with desired color intensity profiles. Thus, the lenslets and their geometrical positioning within the illumination system 12 may control levels of colored light provided onward to a light pipe of the video unit 10 to form an image. As those skilled in the art will appreciate, the term light pipe used herein refers to components and optical connections/coupling of the video unit 10 disposed subsequent to the illumination system 12. As will be described further below, such components of the video unit 10 may include an imaging system, a projection system, a screen, as well as optical devices coupling the aforementioned elements.

Hence, the illumination system 12 utilizes a plurality of LEDs instead of an arc lamp as an illumination source. In other words, rather than employing a lamp and/or light-dispersing/separating components, such as color wheels, dichroic mirrors, polarizes, filters or the like for separating and processing the white light produced by the bulb, the illumination system 12 efficiently combines the light produced by the LEDs at the outset to form colored and white light at various intensities. The video unit 10, therefore, may be made to be smaller in size as compared to systems employing the arc lamps as an illumination source.

As described above, the illumination system 12 may be configured to project, shine, or focus colored light at the imaging system 14. The imaging system 14 may be configured to employ the colored light to create images suitable for display on a screen 24. The imaging system 14 may be configured to generate one or more pixel patterns that can be used to calibrate pixel shifting in the video unit 10. In one exemplary embodiment, the imaging system 14 comprises a DLP imaging system that employs one or more DMDs to generate a video image using the colored light. In another embodiment, the imaging system 14 may employ an LCD projection system. It will be appreciated, however, that the above-described exemplary embodiments are not intended to be exclusive, and that alternate embodiments, any suitable form of imaging system 14 may be employed in the video unit 10.

The imaging system 14 illustrated in FIG. 1 may be configured to project images into a projection lens assembly 16. The projection lens assembly 16 may include one or more lenses and/or mirrors that project the image created by the imaging system 14 onto the screen 24.

FIG. 2 is a block diagram of the illumination system 12 in accordance with an exemplary embodiment of the present invention. As mentioned above, the illumination system 12 includes light generating and gathering components adapted to produce and convey the colored and/or white light to subsequent components of the video unit 10 (FIG. 1). The illumination system 12 includes an LED module 40 adapted to house a plurality of LEDs 42. Each of the LEDs 42 contained within the module 40 may be adapted to emit red, green or blue light. Other embodiments of the present invention may incorporate LEDs, i.e., LEDs 42, adapted to emit light having colors of various colors, some of which may be different from the RGB colors. In an exemplary embodiment, the module 40 may be adapted to house up to eleven LEDs. In other exemplary embodiments, the module 40 may be adapted to house a different number of LEDs, some of which could be greater or less than the aforementioned number of LEDs. In other exemplary embodiments, the illumination system 12 may be adapted to include multiple LED modules, such as the module 40. In such embodiments, each module 40 may be adapted to house a different number of LEDs.

By being adapted to house combinations of RGB LEDs, the module 40 can be configured to provide combinations of light signals that accentuate or suppress specific color(s). For instance, by a suitable choice of LEDs, the video unit 10 can be configured to produce images having hues that are relatively greater in red than blue. This may be achieved by including within the module 40 a greater number of red LEDs than blue LEDs. The module 40 may be adapted to house other combinations of LEDs, such as those envisioned to output light with enhanced and/or suppressed color(s) of specific kinds.

The ability to incorporate and/or change the amount of LEDs within the illumination system 12 is facilitated by a modular design of the module 40. That is, each of the LEDs 42 may be independently coupled to the module 40 such that one or more of the LEDs 42 can be replaced and/or removed form the module 40 with minimal effort. Further, should one or more of the LEDs 42 malfunction or otherwise become idle, the video unit 10 may continue projecting images despite some loss in color and/or brightness. Hence, unlike systems employing arc lamps whose malfunction renders the entire video unit nonfunctional, the present invention enables the video unit to continue operating even though one or more of the LEDs is non operational. Those skilled in the art will further appreciate that the average lifetime of an LED is far greater than the average lifetime of an arc lamp. This yet provides another advantage of using LEDs, such as the LEDs 42, as an illumination source rather than mercury lamps used in conventional systems.

The illumination system 12 further includes a plurality of light collimating elements or collimators 44 adapted to efficiently collect the light produced by the LEDs 42. In an exemplary embodiment, each of collimators 44 may be disposed near or directly adjacent to each of the LEDs 42. In other exemplary embodiments, each of the collimators 44 may surround each of the LEDs 42 such that the LEDs 42 may be partially embedded within the collimators 44. Each of the collimators 44 is adapted to intake a maximal amount of light emanating from the LED to which the collimator is coupled. In so doing, the collimators 44 increase the light gathering ability of the illumination system 12. This ensures that the majority of the light produced by the LEDs 42 is efficiently utilized by subsequent optical components for generating an image.

The illumination system 12 further includes a lenslet assembly 46. The lenslet assembly 46 includes a plurality of optical components, referred herein to as a lenslet. Hence, the lenslet assembly 46 is a collection of individual lenslets. The number of lenslets included in the lenslet assembly 46 corresponds to the number of LEDs 42 included in the module 40. Each of the lenslets is adapted to receive light emitted by a respective LED 42 and collimator 44. Further, after receiving the light emitted by a respective LED, each of the lenslets of the assembly 46 is adapted to redirect the light onto a lens 48 disposed subsequent to the lenslet assembly 46. As will be further shown below, each of the lenslets 46 is geometrically oriented relative to an axis for optimally receiving and redirecting the light emanating from each of the respective LEDs 42 onto the lens 48. In so doing, the lenslet assembly 46 ensures that a maximal amount of light emitted by the LEDs 42 is collected by the lens 48. Further, the lens 48 is adapted to focus the collected light onto an aperture 50. The aperture 50 is adapted to transmit the light into the light pipe comprising additional imaging and projection components, as discussed hereinabove in relation to FIG. 1.

The lenslet assembly 46 is adapted to provide a unique intensity distribution for each of the LEDs 42 at the aperture 50. This intensity distribution may depend on the location of each of the LEDs 42 in the module 40, and on the orientation of the respective lenslets 46 relative to the lens 48 and aperture 50. By virtue of including the lenslet assembly 46 within the illumination system 12, proper intensity levels of the LEDs 42 are obtained at the aperture 50 for projecting a image. In other words, absent the lenslet assembly 46, the light emerging from the LEDs 42 cannot be collected efficiently at aperture 50 for projecting a viewable image.

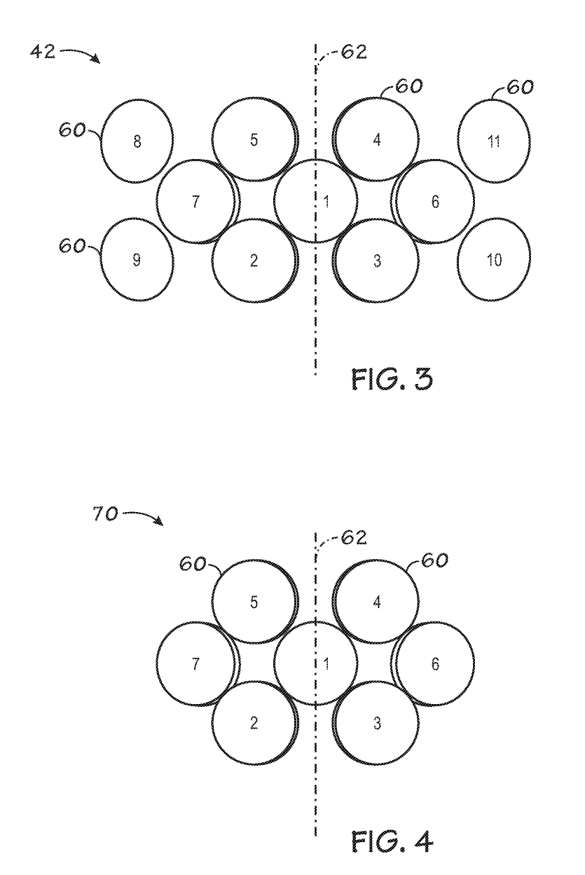

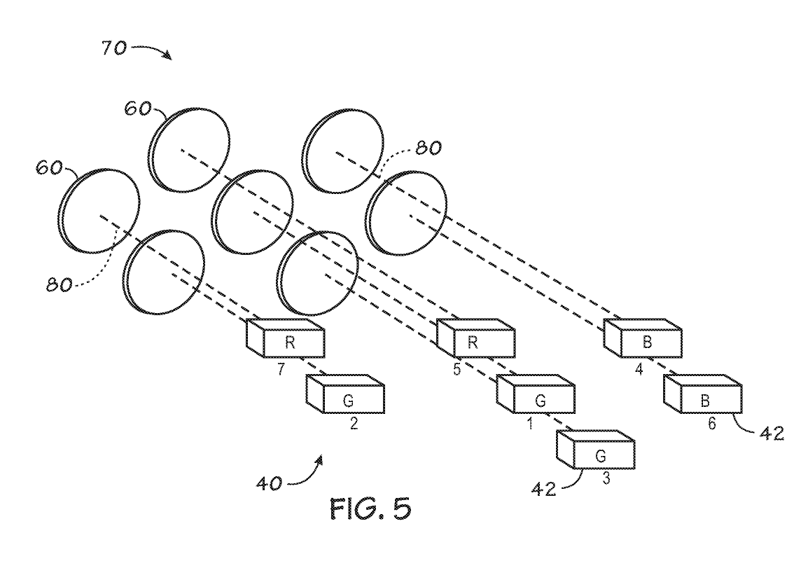

FIG. 3 is a rear view of the lenslet assembly 46, in accordance with an exemplary embodiment of the present invention. FIG. 3 illustrates a configuration of lenslets 60 within the illumination system 12. In the illustrated embodiment, the lenslet assembly 46 forms a two dimensional array made up of eleven lenslets 60. The lenslets 60 are disposed relatively adjacent to one another to form a stack including three rows of the lenslets 60. While the illustrated embodiment may show all of the lenslets 60 as being coplanar, other embodiments may include the lenslets 60 laying on different planes. That is, the configuration formed by the lenslet assembly 46 may posses some degree of concavity/convexity about an axis, such as axis 62 that is perpendicular to the lenslet assembly 46. In addition, the lenslet assembly (46) may be positioned symmetrically or asymmetrically about the axis 62. It should further be born in mind that each of the LEDs 42 of the module 40 is positioned at some distance behind the lenslet assembly 46. As will be shown further below (FIG. 5), each LED 42 is uniquely positioned relative to a respective lenslet 60 for redirecting a desired amount of light from the LEDs 42 onto the aperture 50.

As further illustrated, the lenslets 60 are enumerated from one through eleven. This enumeration corresponds to the spatial positioning of each of the lenslets 60 within the module 40. Furthermore, the spatial positioning of each of the lenslets 60 determines the amount of usable light propagating between the LEDs 42 and the aperture 50. Specifically, the intensities provided by each of the LEDs 42 varies corresponding to the manner each of those LEDs is positioned within the module 40 relative to the lenslets 60. In an exemplary embodiment, efficiencies of useful light redirected by the lenslet assembly 46 and collected at the aperture 50 for each of the eleven LEDs (FIG. 3) are summarized below in Table 1.

TABLE 1

| LED number | % efficiency of useful light transferred |
|---|---|
| 1 | 76% |
| 2, 3, 4, 5 | 58% |
| 6, 7 | 39% |
| 8, 9, 10, 11 | 15% |

As illustrated by Table 1 and FIG. 3, light emerging from LEDs (42) disposed relatively towards the center of the lenslet assembly 46 is received more efficiently at the aperture 50 than the light emerging from LEDs (42) disposed near the outer periphery of the lenslet assembly 46. It should be born in mind that parameters shown by Table 1 may hold for systems having up to eleven LEDs and lenslets 60, such as those discussed above.

Accordingly, FIG. 4 is a rear view of another lenslet assembly in accordance with an exemplary embodiment of the present invention. Lenslet assembly 70 is made up from seven lenslets corresponding to an illumination system, such as system 12, having seven LEDs. As illustrated, up to the seventh lenslet, enumeration of the lenslets 60 of the assembly 70 is similar to that shown with respect the lenslet assembly 46 of FIG. 3. Thus, the lenslet assembly 70 is adapted to process light received from a plurality of LEDs in similar manner with which the assembly 46 operates, as described above. Specifically, the lenslet assembly 70 is adapted to redirect light emanating from seven LEDs onto the aperture of the illumination system.

Further, in an exemplary embodiment, the efficiency percentiles listed in Table 1 can be used as a guideline for constructing an illumination system that accentuates and/or suppresses certain colored light intensities at the aperture 50. For instance, a system may be constructed in which LEDs 1, 2 and 3 are chosen to emit green light. In addition, LEDs 4 and 6 may be chosen to emit blue light, and LEDs 5 and 7 may be chosen to emit red light. With such choices for the LEDs 42, central regions of the aperture 50 (FIG. 2) would be populated with green light, while peripheral regions would be populated with blue and/or red light. It should be appreciated that the efficiency percentile data, such as that provided in Table 1, may be similarly used with illumination systems employing various combinations of LEDs. In this manner, the LEDs 42 can be assembled within the module 40 for providing various desired intensity profiles of colored light at the aperture 50.

FIG. 5 is a perspective view of an LED module disposed relative to the lenslet assembly 70 shown in FIG. 4, in accordance with an exemplary embodiment of the present invention. As illustrated, the LEDs 42, such as those included in the module 40 (FIG. 2), are disposed at a distance behind the lenslets 60. Particularly, each of the LEDs 42 is disposed behind a respective lenslet 60, such that those two elements lie on and are perpendicular to a common line 80. In this manner, light emitted by each of the lenslets 60 is directly captured by each of the lenslets 60 for redirecting the light onto the aperture 50 (FIG. 2).

As further illustrated by FIG. 5, each of the LEDs 42 are chosen to emit a specific light color (in accordance with the example discussed above), providing the aperture 50 a certain color intensity distribution. Accordingly, in the present configuration, the location of the LEDs 42 creates a color distribution that is greener a the central portion of the aperture 50. Similarly, the location of the red and blue LEDs within the module 40 creates color intensity distribution at the peripheral portions of the aperture 50 corresponding to those aforementioned colors. Hence, the color intensity distribution at the aperture 50 directly corresponds to the location of the LED 42 within the module 40.

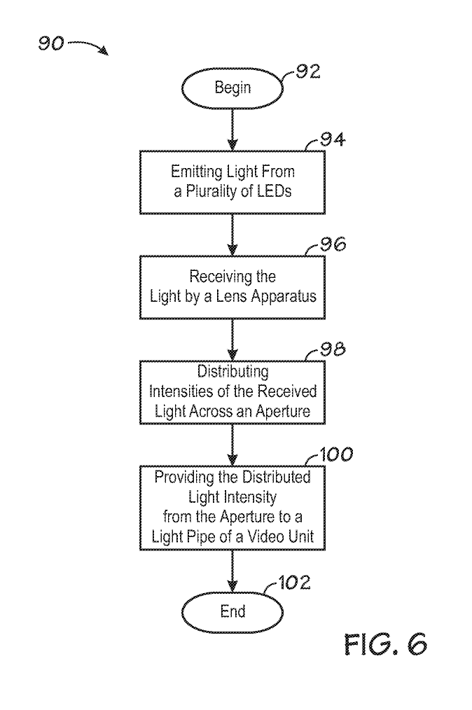

FIG. 6 is a block diagram of a method of operating an illumination system of a video unit in accordance with an exemplary embodiment of the present invention. Method 90 begins at block 92. Thereafter, the method proceeds to block 94, whereby light is emitted from a plurality LEDs of an illuminations system. Thereafter, the method proceeds to block 96, whereby the emitted light is received by a lens apparatus. Such a lens apparatus corresponds to a lenslet assembly, for example, such as the lenslet assembly 46 discussed above with relation to FIGS. 2 and 3. Block 96 may also include collimating the emitted light by collimators, such as the collimators 44. As mentioned above, the collimation increases the amount of light available for projecting an image onto a screen of the video unit.

From block 96, the method 90 proceeds to block 98, whereby the light received by the lenslets is distributed across an aperture. The intensity of light received at the aperture directly corresponds to the location of the LEDs in the module. It should be born in mind that the distribution of light, as performed at block 98, is facilitated by optical attributes of the lenslet assembly, as well as by its geometrical orientation relative to the LEDs and the aperture. Next, the method 90 proceeds to block 100, in which the distributed light is provided from the aperture to a light pipe of the video unit, thereby forming a viewable image. Finally, the method terminates at block 102.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An illumination system, comprising:
a module comprising a plurality of light emitting diodes (LEDs) adapted to emit light;
a plurality of lens elements disposed subsequent to the LEDs, wherein the plurality of lens elements is adapted to distribute intensity of the light emitted by the LEDs across an aperture; and
wherein the intensity of the light at the aperture directly corresponds to the location of the LEDs within the module.

2. The illumination system of claim 1, wherein each of the lens elements is adapted to transmit a different amount of light intensity from the plurality of LEDs.

3. The illumination system of claim 1, wherein the plurality of lens elements forms a two-dimensional array disposed between the plurality of LEDs 42 and the aperture.

4. The illumination system of claim 3, wherein a central portion of the array is more efficient in transferring the light than a peripheral portion of the array.

5. The illumination system of claim 1, wherein a number of lens elements corresponds to a number of LEDs.

6. The illumination system of claim 5, wherein the number of LEDs is five, seven, or eleven.

7. The illumination system of claim 1, wherein each of the LEDs is adapted to emit red, green or blue light.

8. The illumination system of claim 1, wherein each of the lens elements is disposed behind a respective LED, such that the lens element and the respective LED are approximately perpendicular to a line that joins the lens elements and the LEDs.

9. The illumination system of claim 1, wherein the plurality of lens elements is disposed symmetrically transverse relative to a line that bisects the lens elements.

10. The illumination system of claim 1, wherein the plurality of lens elements is disposed asymmetrically transverse relative to the line.

11. A method of operating an illumination system of a video unit, comprising:
emitting light signals from a module comprising a plurality of light emitting diodes (LEDs);
receiving the light by a lens assembly;
distributing the light across an aperture using the lens assembly, wherein the intensity of the light at the aperture directly corresponds to the location of the LEDs within the module; and
providing the distributed light intensity from the aperture to a light pipe of the video unit.

12. The method of claim 11, comprising pulsing the light emitted by each of the plurality of LEDs.

13. The method claim 11, comprising emitting red, green and blue light by the plurality of LEDs.

14. The method of claim 11, comprising collimating the light emitted by the plurality of LEDs before receiving the light by the lens assembly.

15. The method of claim 11, comprising focusing the distributed light intensity by a lens disposed between the lens assembly and the aperture.

16. A video unit, comprising:
an illumination system, comprising:
a module comprising a plurality of light emitting diodes (LEDs) adapted to emit light;
a plurality of lens elements disposed subsequent to the LEDs, wherein the plurality of lens elements is adapted to distribute intensity of the light emitted by the LEDs across an aperture; and
wherein the intensity of the light at the aperture directly corresponds to the location of the LEDs within the module;
an imaging system adapted to form an image based on the light received from the illumination system; and
a projection system adapted to project the image on a screen of the video unit.

17. The video unit of claim 16, wherein each of the lens elements is adapted to transmit a different amount of light intensity from the plurality of LEDs.

18. The video unit of claim 16, wherein the plurality of lens elements forms a two-dimensional array disposed between the plurality of LEDs 42 and the aperture.

19. The video unit of claim 18, wherein a central portion of the array are more efficient in transferring the light than a peripheral portion of the array.

20. The video unit of claim 16, wherein the module comprises five, seven, or eleven LEDs.
